(19) United States
(12) Patent Application Publication
(10) Pub. No.: US 2009/0109825 A1
(43) Pub. Date: Apr. 30, 2009

(54) OPTICAL SCANNING DEVICE

(75) Inventors: Ferry Zijp, Eindhoven (NL); Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,180

(22) PCT Filed: May 4, 2007
(86) PCT No.: PCT/IB2007/051683

§ 371 Date: Nov. 10, 2008

(30) Foreign Application Priority Data
May 12, 2006 (EP) 06113860.8

(51) Int. Cl. G11B 7/00

(52) U.S. Cl. 369/109.01; G9B/7

(57) ABSTRACT

An optical scanning device (3) for scanning a record carrier (2) comprises an objective unit (20) and a diffraction element (14). The objective unit (20) is adapted to transmit an auxiliary radiation beam (21) towards the record carrier (2) in a defocused mode in addition to a main radiation beam (6) that is used for read-out and/or writing operations. The diffraction element (14) defines a measuring region (16) with respect to a spot (44) of the main radiation beam (6) so as to avoid an influence of the auxiliary radiation beam (21) on the main radiation beam (6) reflected. Hence, the performance of read-out and/or writing operations is increased.

The present invention relates to an optical scanning device for scanning record carriers using evanescent coupling of radiation.

### BACKGROUND OF THE INVENTION

In a particular type of high-density optical scanning device, a solid immersion lens (SIL) is used to focus a radiation beam to a scanning spot onto an information layer of a record carrier. A certain distance between the exit face of the SIL and the outer face of the record carrier, for example 25 nm, is desirable to allow evanescent coupling of the radiation beam from the SIL to the record carrier. Evanescent coupling may otherwise be referred to as frustrated total internal reflection (FTIR). Such systems are known as near-field systems, deriving their name from the near field formed by the evanescent wave at an exit face of the SIL. The optical scanning device may use blue semiconductor laser as radiation source that emits a radiation beam having a wavelength of approximately 405 nm.

During scanning of the record carrier the evanescent coupling between the exit face of the SIL and the outer face of the record carrier should be maintained. An efficiency of this evanescent coupling may vary with a change in the distance of the gap between the exit face and the outer face. With an increase away from a desired gap distance the coupling efficiency will tend to decrease and consequently a quality of the scanning spot will also decrease. If the scanning function involves reading data from the record carrier, for example, this decrease in efficiency will result in a decrease in the quality of the data being read, possibly with the introduction of errors into the data signal.

In far field (non near-field) systems, such as compact disc (CD), digital versatile disc (DVD) or Blu-ray disc (BD), it has been known that tilt misalignment of the record carrier with respect to an optical axis of an objective lens system can adversely affect quality of the scanning spot during writing to and reading from the information layer.

Changes in tilt misalignment may be attributed to an unevenness of a planarity of the record carrier. This may be due to warping of the disc, possibly due to environmental factors such as high temperatures over time or to a low quality manufacturing process of the record carrier. Alternatively, or in addition, tilt misalignment may be caused by poor clamping of the record carrier within the scanning device.

For optical scanning devices that are not of a near-field type, systems are known which allow a tilt misalignment of a record carrier to be measured and corrected for. One conventional system involves using a tilt detector to detect a tilt misalignment of the record carrier and to correct the tilt misalignment based on the extent of the detected tilt misalignment. A different conventional system involves performing an optimization routine during which data is first written to the record carrier and then read. The quality of the read data is then determined as a function of the tilt misalignment. This allows the tilt misalignment to be corrected for, if necessary.

Use of a conventional tilt detector for detecting tilt misalignment of the record carrier would not provide a sufficient level of accuracy in a near-field system due to the very small tolerances involved, and further would require a high degree of alignment of the objective system with respect to the tilt detector. Exceeding such small tolerances may lead to contact between the SIL and the record carrier, possibly damaging the SIL and/or the record carrier.

Use of an optimization routine, similar to the known systems, for measuring and estimating tilt misalignment in a near-field system would not be practical.

### SUMMARY OF THE INVENTION

It is an object of the invention to provide an optical scanning device and a method for accurately and efficiently scanning record carriers using evanescent coupling by allowing a tilt misalignment between the optical scanning device and a record carrier to be detected and corrected for, especially to enable a tilt misalignment between the optical scanning device and a record carrier to be detected and corrected for during normal operation of the optical scanning device.

In accordance with the present invention, there is provided an optical scanning device for scanning a record carrier as defined in claim 1, an optical recording apparatus as defined in claim 16 and a method of scanning a record carrier as defined in claim 17. Advantageous developments of the invention are mentioned in the dependent claims.

It is noted that the tilt control as such may be used independent from read-out or writing operations. For example, a tilt control may also be performed during an approach of the objective lens to the record carrier. But, the measuring region is defined so that the tilt control is enabled even during read-out and/or writing operations.

For near-field systems using evanescent coupling to scan record carriers, a deviation from a desired level of tilt alignment has a detrimental effect on the quality and accuracy of data being written and/or read during scanning of the record carrier. Near-field systems employing evanescent coupling have relatively small margins of mechanical tolerance, outside of which the efficiency of the evanescent coupling deteriorates. A deviation from the desired level of tilt alignment exceeding these tolerance margins can cause this deterioration in the efficiency and therefore a detrimental effect on the data quality and accuracy. Moreover, such a deviation will cause the SIL to make contact with the record carrier, possibly causing damage and/or failure of the system.

With a variation in the tilt misalignment, an efficiency of evanescent coupling across the gap varies across the exit face. Consequently, the efficiency of evanescent coupling across the gap at a first exit face area may be different to the efficiency of evanescent coupling across the gap at a second exit face area. By detecting information indicating the variation of the efficiency across the exit face area, a tilt error signal may be produced.

Simultaneous detection of both the tilt misalignment and gap width makes it possible to simultaneously correct errors in and control of the tilt alignment and gap width. This improves the scanning performance of the optical scanning device and reduces the risk of physical contact between the objective lens system and the record carrier surface, which may result in damaging the record carrier and/or objective lens system.

In embodiments of the present invention, the optical scanning device includes a tilt misalignment control system that is arranged to adjust the tilt misalignment in accordance with tilt error signals.

The tilt error signals can be used to correct the tilt misalignment such that an improved efficiency of evanescent coupling across the total exit face area of the objective lens of the objective unit may be achieved. The record carrier may therefore be scanned with a relatively high quality and level of accuracy. Additionally, the detection and correction of the tilt misalignment itself does not involve, but may be accompanied by writing of data on the disc. A tilt misalignment correction procedure is therefore relatively quick and does not necessarily require use of data capacity of the record carrier.

In accordance with embodiments of the present invention, tilt misalignment about both a first tilt axis and a second tilt axis may be detected and adjusted. This is achieved by a detection of an efficiency of evanescent coupling across the gap at different parts of the measuring region. A radiation detector comprises a plurality of auxiliary radiation detector elements so as to measure an intensity of the auxiliary radiation beam reflected by the exit surface of the objective lens with respect to each of these parts of the measuring region. Thereby, measurement of the intensity of the radiation beam reflected is a way to measure the efficiency of evanescent coupling across the gap.

In some embodiments of the present invention, the radiation generated by a radiation source system is a radiation beam, from which the auxiliary beam is generated, and the device is arranged to introduce defocus into the auxiliary radiation beam such that the auxiliary radiation beam is not focused onto an outer face of the record carrier, thereby increasing a diameter of the beam at the exit face of the objective lens.

Preferably in these embodiments, the device is arranged to introduce defocus into the auxiliary radiation beam such that a cross-sectional area or beam profile of the auxiliary radiation beam at the exit face covers at least one quarter of a total area of the exit face.

The radiation beam at the exit face has an increased diameter, so that a cross sectional area of the auxiliary radiation beam covers at least one quarter of a total area of the exit face. This increased diameter results in an increase of the area of, for example, first, second, third and fourth exit face areas. This allows a greater amount of information of the efficiency of the evanescent coupling across the exit face to be detected and consequently allows a more accurate adjustment of the tilt misalignment to be performed.

In one embodiment of the present invention, adjustment of the tilt misalignment is performed during a start-up procedure after a record carrier has been installed within the device to produce a corrected tilt alignment, the corrected tilt alignment being maintained, after start-up, and used when scanning the record carrier at different points across said record carrier.

By producing a corrected tilt alignment during the start-up procedure and maintaining the corrected tilt alignment after start-up, the record carrier may be accurately scanned without needing to adjust a tilt misalignment during scanning of the record carrier after the start-up procedure.

In a different embodiment of the present invention the adjustment of the tilt misalignment is performed after a record carrier has been installed within the device, wherein the tilt misalignment is adjusted when scanning the record carrier at different points across said record carrier.

By adjusting the tilt misalignment at different points across the record carrier, it is possible to accurately scan a record carrier having a changeable surface tilt, for example across a radius in the case of the record carrier being a disc. Such record carriers may have been manufactured to a poor level of quality, or may have deteriorated, for example by developing a warp, due to environmental conditions.

It is advantageous that the diffraction element generates the auxiliary radiation beam from the main radiation beam, wherein the diffraction element is preferably a concentric (blazed) grating that is apodized, that means fully transparent and unstructured in the center for generating the main radiation beam focused on a layer of the record carrier by the objective unit. Such a diffraction element has the advantage that a high read/write performance is achieved, and that a small fraction, for example 10%, of the radiation beam intensity is used for generating the auxiliary radiation beam.

It is advantageous that a beam profile or a cross-sectional area of the main radiation beam is separated from the measuring region by a separating region. Then, the reliability of reading and/or writing operations is high, even when a tilt correction is performed during such an operation. Thereby, the diffraction element may be adapted so that the measuring region comprises a preferably circular area, and that the objective unit is adapted so that the beam profile of the main radiation beam is preferably circular and is arranged inside that area.

It is further advantageous that a boundary of the measuring region is determined with respect to constraints of the optical scanning device, especially the characteristic features of the objective unit. For example, the objective lens of the objective unit may comprise a tip having a flat area that has to be arranged parallel to a flat surface of the opposing front surface of the record carrier. In such a case the boundary of the measuring region is preferably arranged inside the flat area of the tip of the objective lens including an edge spacing.

The optical scanning device may comprise a radiation detector having two detector elements so as to enable a one-dimensional tilt correction. Another example of a radiation detector is a radiation detector comprising four different auxiliary radiation detector elements, each of the auxiliary radiation detector elements is provided to detect an intensity of the auxiliary radiation beam reflected by the exit surface of the objective lens with respect to a specific part of the measuring region. This enables a two-dimensional tilt correction. Depending on the application, the radiation detector may also comprise a main radiation detector element for detecting an intensity of the main radiation beam reflected by the exit surface of the objective lens to produce a gap error signal.

Further features and advantages of the invention will become apparent from the following description of preferred embodiments of the invention, given by way of example only, which is made with reference to the accompanying drawings.

### BRIEF DESCRIPTION OF THE DRAWINGS

The present invention will become readily understood from the following description of preferred embodiments thereof made with reference to the accompanying drawings, in which like parts are designated by like reference signs and in which:

FIG. 1 shows an optical recording apparatus with a record carrier loaded according to a preferred embodiment of the present invention;

FIG. 2 shows a record carrier and an objective unit of an optical scanning device of the optical recording apparatus shown in FIG. 1;

FIG. 3 shows a radiation detector of an optical scanning device of an optical recording apparatus shown in FIG. 1;

FIG. 4 illustrates an arrangement of a measuring region for a tilt control with respect to an exit surface of an objective lens of an objective unit of the optical scanning device of the optical recording apparatus shown in FIG. 1; and

FIG. 5 shows a radiation detector arrangement of an optical scanning device of an optical recording apparatus according to a further preferred embodiment of the present invention.

### DETAILED DESCRIPTION OF THE INVENTION

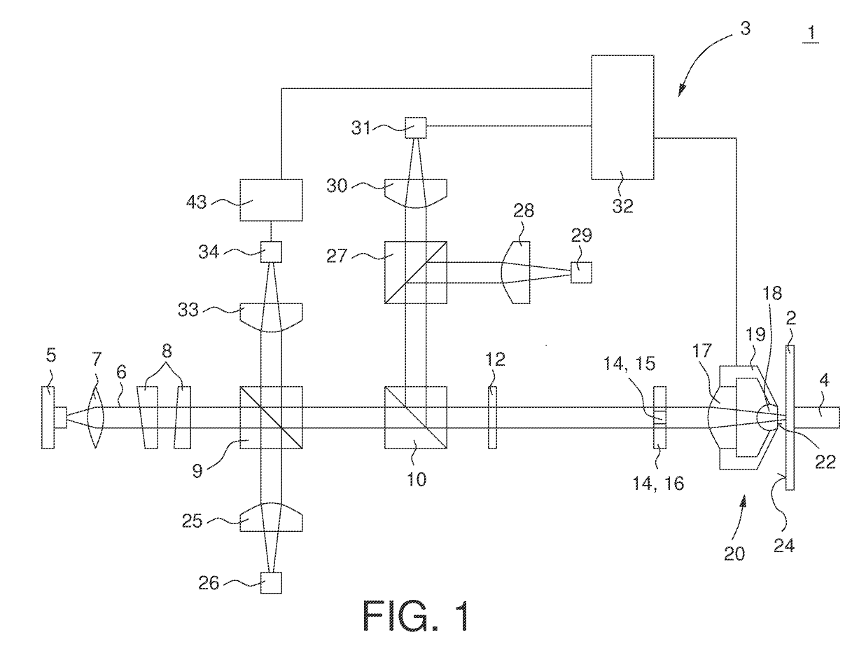

FIG. 1 shows a schematic illustration of an optical recording apparatus 1 for scanning a record carrier 2 in accordance with a preferred embodiment of the present invention. The optical recording apparatus 1 comprises an optical scanning device 3 and a mounting element 4, especially a rotating shaft 4, for rotating the record carrier 2. The optical recording apparatus 1 and the optical scanning device 3 are especially used in combination with a solid immersion lens for high-density optical scanning applications. But, the optical recording apparatus 1 and the optical scanning device 3 may also be used in other applications and in combination with other optical or non-optical reading and/or writing procedures.

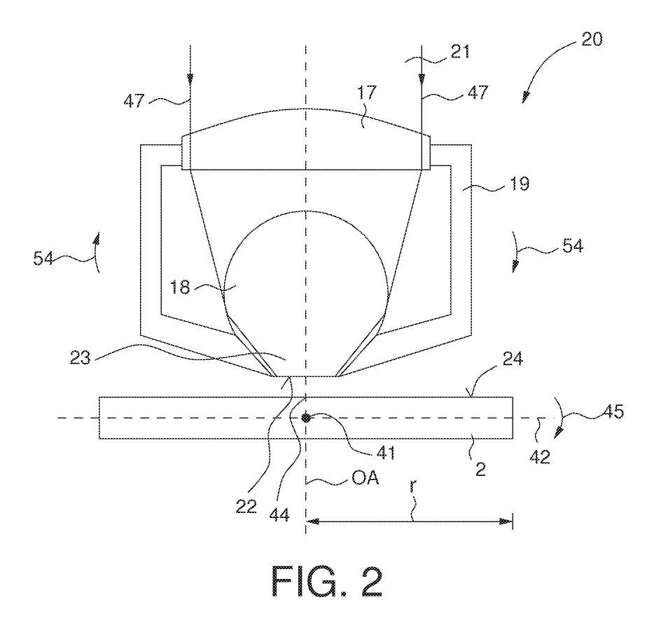

The optical scanning device comprises a radiation source system 5 which is arranged to generate a radiation beam 6. In this embodiment the radiation source system 5 is a laser 5 and the radiation beam 6 is a laser beam 6 having a predetermined wavelength λ, for example approximately 405 nm. During both a start-up procedure and a record carrier scanning procedure of the optical scanning device, the radiation beam 6 passing along an optical axis OA (FIG. 2) of the optical scanning device 3 is collimated by a collimator lens 7 and its cross-sectional intensity distribution is shaped by a beam shaper 8. The radiation beam 6 then passes through a non-polarizing beam splitter 9, followed by a polarizing beam splitter 10 and is then passing through a λ/4-waveplate 12 and a diffraction element 14. The diffraction element 14 comprises a transparent and unstructured center 15 for generating a main radiation beam focused on a layer of the record carrier 2 by an objective unit 20. Further, the diffraction element 14 comprises a concentric grating 16 for generating an auxiliary radiation beam 21 (FIG. 2). Thereby, the objective unit 20 transmits the auxiliary radiation beam 21 towards the record carrier 2 in a defocused mode in addition to the main radiation beam 6, wherein the main radiation beam 6 is to incident on the record carrier 2 for read-out and/or writing operations. It is noted that the main radiation beam may be focused on a specific layer of the record carrier 2, and, in case that the record carrier 2 comprises two or more layers, the objective unit 20 may also switch the focus between different layers of the record carrier 2. The objective unit 20 of the optical scanning device comprises an objective lens 17 which introduces a focusing wavefront into the main radiation beam 3. The objective system 20 further comprises an objective lens 18, especially a solid immersion lens (SIL) 18, which is fixed to the objective lens 17 by a supporting frame 19. The supporting frame 19 ensures that an alignment and a separation distance of the objective lens 17 with the SIL 18 is maintained. The objective system has an exit surface 22 which is planar and is an exit surface 22 of a tip 23 of the SIL 18.

The record carrier 2 to be scanned by the optical scanning device 3 is arranged on the mounting element 4 within the optical scanning device 3. The mounting element 4 includes a clamping arrangement (not indicated) that ensures that the record carrier 2 is held rigidly and correctly in place on the mounting element 4 during scanning. With the record carrier 2 being rigidly held in place, the mounting element 4 provides for a translation in this embodiment of a rotation of the record carrier 2 in relation to a radiation scanning spot being used to scan data tracks of the record carrier 2. In this embodiment the tracks are rotated in a direction perpendicular to the optical axis OA. The record carrier 2 has an outer surface 24 which faces the exit surface 22 of the SIL 18. In this embodiment the record carrier 2 is formed of silicon and the outer surface 24 is a surface of an information layer of the record carrier 2 through which the radiation beam enters the record carrier 2.

The optical scanning device 3 has an optical axis (not indicated) and the objective unit 20 is arranged on the optical axis between the laser 5 and the record carrier 2. The objective unit 20 provides for evanescent coupling of the radiation beam 3 across a gap between the exit surface 22 of the SIL 18 and the outer surface 24 of the record carrier 2. Between the exit surface 22 of the SIL 18 and the outer surface 24 of the record carrier 2 there may be a tilt misalignment.

The maximum information density that can be recorded, for example, on a record carrier 2 scales inversely with the size of the radiation spot that is focused onto a scanning position on the information layer. The minimum spot size is determined by the ratio of two optical parameters: the wavelength λ of the radiation and a numerical aperture (NA) of the objective unit 20. The NA of an objective lens 18 such as a SIL is defined as NA=n sin (θ), with n the refractive index of the medium in which the radiation beam is focused and θ the half angle of the focused cone of radiation in that medium. It is evident that the upper limit for the NA of objective lenses that focuses in air or through air in a plane parallel plate such as a planar record carrier, is unity. The NA of a lens can exceed unity if the radiation beam 6 is focused in a high index medium and passes to an object 2 without refraction at the medium air-medium interface between the lens and the object. This can be achieved, for example by focusing in the center of an exit face 22 of a SIL 18 having a hemispherical shape, the SIL 18 being in close proximity to the object 2. In this case the effective NA is NA_{eff}=n NA₀ with n the refractive index of the hemispherical lens 18 and NA₀ the NA in air of the focusing lens. A possibility to further increase the NA is the use of a SIL 18 having a super-hemispherical shape in which the super-hemispherical SIL 18 refracts the radiation beam 6 towards the optical axis and focuses it below the center of the super-hemisphere. In the latter case the effective NA is NA_{eff}=n² NA₀. It is important to note that an effective NA_{eff} larger than unity is only present within an extremely short distance (also called the near-field) from the exit surface 22 of the SIL 18, where an evanescent wave exists. In this embodiment the exit surface 22 is the last refractive surface of the objective unit 20 before the radiation impinges on the object 2. The short distance is typically less than one tenth of the wavelength λ of the radiation beam 6.

When the object 2 is an optical record carrier 2 and an outer surface 24 of the optical record carrier 2 is arranged within this short distance, radiation is transmitted from the SIL 18 to the record carrier 2 by evanescent coupling. This means that during writing or read-out of a record carrier 2, the distance between the SIL 18 and record carrier 2, also called the gap size, is preferably smaller than a few tens of nanometers, for example, about 25 nm for an apparatus 1 using a blue laser radiation source to generate a radiation beam 6 having a wavelength λ equal to approximately 405 nm and an NA of the objective system of 1.9.

The optical scanning device 3 has a first detection path and a second detection path that are both arranged in a path of the radiation beam 6 following a reflection by the record carrier 2.

Further, the optical scanning device 3 has a forward sense detection path comprising a condenser lens 25 and a forward sense detector 26.

The first detection path of the optical scanning device 3 branches off from the polarizing beam splitter 10 and comprises a beam splitter 27. From the beam splitter 27 a part of the radiation beam reflected from the record carrier 2 passes through a condenser lens 28 onto a radio frequency data detector 29. Another part of the radiation beam 6 reflected passes through a further condenser lens 30 onto a tracking detector 31 that is connected with a control unit 32 to enable push and pull operations for a tracking of the spot of the radiation beam 6 on the record carrier 2 with respect to a specific track of the record carrier 2. Therefore, the control unit 32 is connected with the supporting frame 19.

The second detection path branches off from the non-polarizing beam splitter 9. In the second detection path of the optical scanning device 3 there is arranged a condenser lens 33 and a radiation detector 34, wherein the condenser lens 33 is adapted to focus at least a part of the auxiliary radiation beam reflected onto the radiation detector 34. The radiation detector 34 is connected with a signal processing circuit 43 that is arranged to produce tilt error signals with respect to a tilt misalignment between the exit surface 22 of the objective lens 18 and the outer surface 24 of the record carrier 2. Thereby, the signal processing circuit 43 may be a part of the radiation detector 34. The tilt error signals are produced by a detection of information in a detection radiation beam of a distribution across the exit surface 22 of an intensity of the reflected auxiliary radiation beam 21. This distribution of intensity is indicative of a variation in efficiency of the evanescent coupling across the exit surface 22, as described in further detail with reference to FIG. 2.

The signal processing circuit 43 is connected with the control unit 32 and sends the tilt error signals to the control unit 32. The control unit 32 provides a tilt misalignment correction procedure on the basis of the tilt error signals received from the radiation detector 34. Therefore, the control unit 32 controls actuator elements of the support frame 19 to tilt the objective unit 20 and/or actuator elements to tilt the mounting element 4 and therewith the record carrier 2.

FIG. 2 shows the objective unit of the optical recording apparatus 1 according to a preferred embodiment of the invention. To enable reading and writing of data, a distance of a gap between the exit surface 22 of the objective lens 18 and the outer surface 24 of the record carrier 2 has to be controlled.

To allow control of the distance of the gap a suitable error signal is required. As detailed by Sony and referenced herein (T. Ishimoto et al., Proceedings of Optical Data Storage 2001 in Santa Fe), a good gap signal (GS) is obtained from reflected radiation with a polarization state perpendicular to that of the radiation beam focused on the record carrier. A significant fraction of radiation of the radiation beam becomes elliptically polarized after reflection at the exit face and the outer faces. This creates the well-known Maltese cross when the reflected radiation is observed through a polarizer. The GS is generated by integrating all the light of this Maltese cross using polarizing optics and a single photodetector. The GS is derived from a low-frequency, for example DC to approximately 30 kHz, part of the detection radiation beam focused also on the radiation detector 34.

It is noted that for circular polarization of the main beam, the reflected light also becomes elliptical, but the Maltese cross is not visible due to a rotating at optical frequency.

In a scanning function, for example data recording, very short, high-power laser pulses are emitted by the laser 5. These pulses dynamically change the (average) laser power, leading to corresponding changes in the GS corresponding to a size of the gap between the exit surface 22 and the outer surface 24, and, due to a gap servo system, also in the gap for the optical scanning device. For example, if the laser power increases suddenly, the GS will also increase. The gap servo system, however, will reduce the air gap size in order to arrive at a desired gap size again. A similar effect occurs during data reading when the laser power changes, e.g. due to temperature drift. This GS normalization uses the forward sense detector 26.

The push-pull detector 31 detects from a detection radiation beam a radial tracking error of the radiation beam spot on a track of the information layer of the record carrier 2. The push-pull detector 31 detects radiation that is polarized parallel to a direction of polarization of the radiation beam that is focused on the record carrier 2.

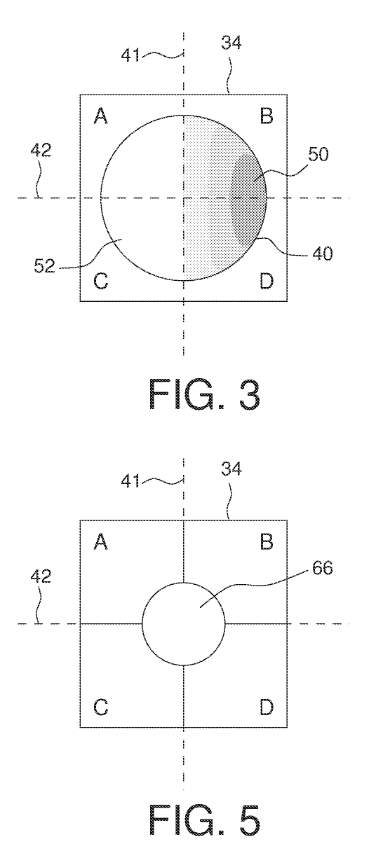

Referring now to FIG. 3, the radiation detector 34 is shown having a first, second, third and fourth detection quadrant area A, B, C, D respectively. During a tilt misalignment detection procedure the detection auxiliary radiation beam spot 40 falls on the radiation detector 34. The detection radiation beam spot 40 has a predetermined level of defocus, as explained below.

The tilt misalignment includes a tilt misalignment about a first tilt axis 41 which is perpendicular to the optical axis OA (as shown in FIG. 2). The tilt misalignment further includes a tilt misalignment about a second tilt axis 42 which is substantially perpendicular to the optical axis OA and the first tilt axis 41.

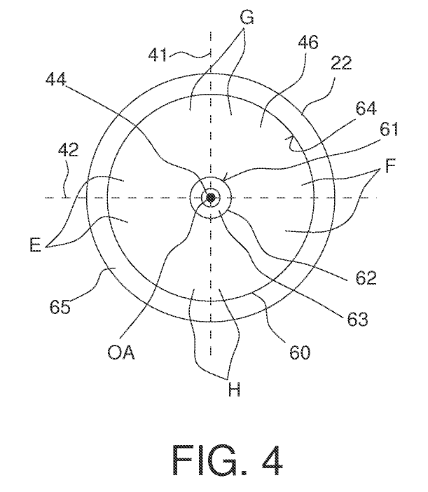

The radiation detector 34 that is a quadrant detector 34 includes a first detection area made up of the second and the fourth detection quadrant areas B, D, a second detection area made up of the first and the third quadrant areas A, C, a third detection area made up of the first and the second quadrant areas A, B, and a fourth detection area made up of the third and fourth quadrant areas C, D. Referring to FIG. 4 the exit surface 22 (illustrated in FIG. 4 and viewed in a direction along the optical axis OA from the record carrier 22 to the objective unit 20) includes a first exit surface area E and a second exit surface area F which are mutually displaced to opposite sides of the first tilt axis 41. The exit surface 22 further includes a third exit surface area G and a fourth exit surface area H which are mutually displaced to opposite sides of the second tilt axis 42.

During the tilt misalignment detection procedure the first, second, third and fourth detection areas A, B, C, D are each arranged to detect information in the detection radiation beam spot 40 which is indicative of an efficiency of the evanescent coupling between the exit surface 22 and the outer surface 24. A signal processing circuitry 43 connected to the radiation detector 34 is arranged to produce a first detector signal α₁ which represents the efficiency of the evanescent coupling across the first exit face area E. Similarly, the signal processing circuitry 43 is arranged to produce a second detector signal α₂ which represents the efficiency of the evanescent coupling across the second exit face area F, to produce a third detector signal β₁ which represents the efficiency of the evanescent coupling across the third exit face area G and to produce a fourth detector signal β₂ which represents the efficiency of the evanescent coupling across the fourth exit face area H.

The first detector signal α₁ is a sum of a second quadrant area signal produced by the second quadrant area and a fourth quadrant area signal produced by the fourth quadrant area. The second detector signal α₂ is a sum of a first quadrant area signal produced by the first quadrant area and a third quadrant area signal produced by the third quadrant area. The third detector signal β₁ is a sum of a first quadrant area signal produced by the first quadrant area and a second quadrant area signal produced by the second quadrant area. The fourth detector signal β₂ is a sum of a third quadrant area signal produced by the third quadrant area and a fourth quadrant area signal produced by the fourth quadrant area.

For each detection area, the efficiency of the evanescent coupling across an exit face area, for example the first exit face area E, is detected by detecting an intensity of radiation of the detection radiation beam spot 40 falling on the corresponding detection area, for example the first detection area. A relatively high intensity of radiation falling on the detection area indicates a relatively low efficiency of evanescent coupling across the corresponding exit face area. In contrast, a relatively low intensity of radiation falling on the detection area indicates a relatively high efficiency of evanescent coupling across the corresponding exit face area.

The signal processing circuitry 43 is arranged to produce a first tilt error signal α according to the relationships of equations 1 and 2:

$$\begin{matrix}α = \frac{{α}_{1} - {α}_{2}}{{α}_{1} + {α}_{2}} & ( 1 ) \\ α = \frac{( B + D ) - ( A + C )}{( B + D ) + ( A + C )} & ( 2 )\end{matrix}$$

Additionally, the signal processing circuitry 43 is arranged to produce a second tilt error signal β according to the relationships of equations 3 and 4:

$$\begin{matrix}β = \frac{{β}_{1} - {β}_{2}}{{β}_{1} + {β}_{2}} & ( 3 ) \\ β = \frac{( A + B ) - ( C + D )}{( A + B ) + ( C + D )} & ( 4 )\end{matrix}$$

The control unit 32 is arranged to vary the tilt misalignment about the first tilt axis 41 in accordance with the first tilt error signal α and to vary the tilt misalignment about the second tilt axis 42 in accordance with the second tilt error signal β.

When a cross-sectional area of the detection radiation beam spot 40, as shown in FIG. 3 has a uniform radiation intensity which is characteristic of the desired tilt misalignment, the first, second, third and fourth detector signals α₁, α₂, β₁, β₂ would be approximately equal and consequently the first and second tilt error signals α, β would be such that the control unit 68 does not need to vary the tilt misalignment.

The SIL 18 of the objective unit 20 in the embodiment shown in FIG. 2 has a conical super-hemispherical shape with the exit surface 22 facing the outer surface 24. A diameter of the exit surface 22 is approximately 40 μm and the NA of the SIL is 1.9. A desired tilt alignment is illustrated in FIG. 2 where the exit surface 22 is substantially parallel the outer surface 24 and both the exit surface 22 and the outer surface 24 are substantially perpendicular to the optical axis OA.

FIG. 2 shows the objective unit 20 and the record carrier 22 having a desired tilt alignment such that during a scanning function of the optical scanning device, for example a data writing procedure, a scanning main radiation beam is focused to a spot 44 on the information layer 24 of the record carrier 22. This is achieved when a distance across the gap between the outer surface 24 and the exit surface 22 is less than approximately one tenth of the wavelength λ of the radiation beam. This ensures that an efficient evanescent coupling across the gap for a total area of the exit surface 22 is achieved. In the example of data writing, the focused spot 44 will allow data to be written accurately onto the information layer 24. When the desired tilt alignment is not present, the quality of the spot 44 on the information layer 24 of the record carrier is affected.

FIG. 3 shows a pattern in the detection auxiliary radiation beam spot 40 illustrating a non-uniform intensity distribution in a case in which the record carrier 2 is inclined with respect to the first tilt axis 41 in a direction 45, as shown in FIG. 2. In this case the tilt misalignment is about the first tilt axis 41. Hence, this case illustrates a situation where the tilt misalignment is in one direction about the first tilt axis 41. In case that the tilt misalignment is in one direction about the second tilt axis 42, the following description applies accordingly. Further, an arbitrary tilt misalignment, that is a tilt misalignment in two dimensions or two directions, may be viewed as a combination of the tilt misalignment about the first tilt axis 41 and a tilt misalignment about the second tilt axis 42. With a non-desired tilt misalignment, the exit surface 22 and the outer surface 24 are not substantially parallel to each other and the outer surface 24 and/or the exit surface 22 are not substantially perpendicular the optical axis OA.

During the tilt misalignment correction procedure the optical scanning device 3 is arranged to introduce defocus into the auxiliary radiation beam 21 such that the auxiliary radiation beam 21 is not focused within the record carrier 2, thereby increasing a diameter of a spot 46 (FIG. 4) of the auxiliary radiation beam 21 at the exit surface 22. The defocus is introduced into the auxiliary radiation beam 21 such that a cross-sectional area of the auxiliary radiation beam 21 at the exit surface 22 covers at least one quarter of a total area of the exit surface 22, preferably at least one half of the total area and more preferably approximately all of a total area of the exit surface 22. In this embodiment the diameter of the defocused spot at the exit surface 22 is at least 10 μm, preferably approximately 20 μm.

Referring to FIGS. 2, 3 and 4, during the tilt misalignment detection procedure rays 47 of the auxiliary radiation beam 21 pass through the objective unit 20 and strike the outer surface 24 of the record carrier 2. Due to the inclination of the record carrier 2 in the direction 45, the gap between the exit surface 22 and the outer surface 24 on the left-hand side of the optical axis OA, therefore corresponding with the first exit surface area E, is relatively smaller than the gap on the right-hand side of the optical axis OA which corresponds with the second exit surface area F. The record carrier 22 in this embodiment has a radius r that lies in a plane of the outer surface 24 and extends outwards from a center point of the record carrier 2. The center-point is coincident with an intersection between the first tilt axis 41 and the second tilt axis 42. The gap gets smaller in size across the first exit face area E in an outwards direction from the center point along the radius r. The gap gets larger in size across the second exit face area F in an outwards direction from the center point along the radius r. Upon striking the outer surface 24, the rays 47 are partially transmitted by the outer surface 24 and subsequently absorbed and reflected within the record carrier 2 and partially reflected by the outer surface 24. Additionally, the rays 84 may be totally internally reflected on the exit surface 22 of the SIL 18.

Proportions of the rays 47 which are reflected and absorbed depend on the size of the gap. When the gap is larger than desired, the efficiency of evanescent coupling across the gap is relatively low and fewer of the rays 47 are transmitted across the gap to the outer surface 24. This leads to a greater proportion of the rays 47 being internally reflected by the inside surface of the exit surface 22. A portion of those rays 47 which reach the outer surface 24 is reflected by the outer surface 24 and a portion is transmitted by the outer surface 24. The rays may be absorbed by a material from which the record carrier 2 and/or the outer surface 24 is formed, or by a destructive interference of the rays upon interaction with structural features of the entrance layer 24 and/or information layer such as pits and embossments.

With the gap across the second exit face area F being larger than desired, the gap across the first exit face area E is smaller than desired. In this situation, the evanescent coupling is of a relatively high efficiency across the first exit face area E and a greater proportion of the rays 47 across the first exit face area E are transmitted to the outer surface 24. As a consequence, a greater proportion of the rays 47 across the first exit face area E are absorbed by the outer surface 24 and within the record carrier 2. Less of the rays 47 are therefore reflected by the outer surface 24 and the inside surface of the exit surface 22.

Reflection of the rays 47 by the exit surface 22 of the SIL 18 of the objective unit 20 and by the outer surface 24, introduces information in the radiation reflected by the objective unit 20 which is indicative of the efficiency of the evanescent coupling of the radiation between the objective unit 20 and the record carrier 2. The reflected rays 47 constitute a detection radiation beam which passes along the optical axis OA through the polarizing beam splitter 10, the non-polarizing beam splitter 8, and then passes along the second detection path via the condenser lens 33 to the quadrant detector 34.

FIG. 3 shows the detection auxiliary radiation beam spot 40 falling on the quadrant detector 34 in accordance with the tilt misalignment in the one direction about the first tilt axis 41. Across the first detection area 50 a relatively low overall intensity of the detection radiation beam is detected which corresponds to a low proportion of the rays 47 across the area of the first exit surface area E being reflected by both the inside surface of the exit surface 22 and the outer surface 24. Across the second detection area 52 a relatively high overall intensity of the detection radiation beam is detected which corresponds to a relatively high proportion of the rays 47 across the second exit surface area F being reflected by both the inside surface of the exit surface 22 and the outer surface 24.

By detecting a relatively low overall intensity of radiation across the first detection area 50 a first detector signal α₁ is produced which has a relatively low magnitude. By detecting a relatively high overall intensity of radiation across the second detection area 52 a second detector signal α₂ is produced which has a relatively high magnitude. The signal processing circuitry 43 produces the first tilt error signal α in accordance with equations 1 and 2. The control unit 32 receives this first tilt error signal α and controls the actuator to vary the tilt of the objective unit 20 in a tilt misalignment correction direction 54, as shown in FIG. 2, so as to achieve the desired tilt misalignment, as described previously, in which the exit surface 22 and the outer surface 24 are substantially parallel each other. During variation of the tilt of the objective unit 20, the magnitude of the first and the second detector signals α₁, α₂ varies as the intensity of radiation being detected by both the first detector area 50 and the second detector area 52 varies. As a result, the first tilt error signal α varies and the control unit 32 monitors this variation. Once the control unit 32 identifies that the first tilt error signal α is at least approximately the same as a first tilt error signal α which is characteristic of the desired tilt misalignment, the control unit 32 stops the actuator's variation of the tilt of the objective unit 20. At this point the tilt misalignment about the first tilt axis 41 is corrected for.

The control unit 32 receives the first tilt error signal α and controls the actuator to vary the tilt of the objective unit 20 in a tilt misalignment correction direction 54, as shown in FIG. 2, so as to achieve the desired tilt misalignment. This involves, as described previously, the control unit 32 identifying when the first tilt error signal α is the same as a first tilt error signal α which is characteristic of the desired tilt alignment and stopping the actuator's variation of the tilt of the objective unit 20 at this point.

In addition to detecting and correcting a tilt misalignment about the first axis 41, the tilt misalignment correction procedure also includes detecting and correcting a tilt misalignment about the second tilt axis 42, in a similar manner to detecting and correcting the tilt misalignment about the first tilt axis 41 as previously described.

The signal processing circuitry 43 produces the second tilt error signal β, in accordance with equations 3 and 4 which is dependent on the magnitude of the third and fourth detector signals β₁ and β₂. The magnitude of the third and fourth detector signals β₁ and β₂ depends on an intensity of radiation of the reflected rays of the detection radiation beam falling on the third and fourth detection areas, respectively. As described previously, the intensity of radiation falling on the detection areas depends on an efficiency of evanescent coupling across the gap. The actuator varies the tilt of the objective unit 20 in a tilt misalignment correction direction about the second tilt axis 42 until the second tilt error signal β is the same as a second tilt error signal β which is characteristic of the desired tilt misalignment.

Following the tilt misalignment correction procedure, the optical scanning device 3 performs a scanning function, for example writing of data to or reading of data from the record carrier 2.

In the described embodiment of the present invention as illustrated using FIGS. 1 to 4, the tilt of the objective system is adjusted to achieve a desired tilt alignment. A maximum range of tilt variation of the objective system with respect to the optical axis OA is approximately 0.07° to 0.28° with the objective system having such a tilt within this range, the gap size is approximately one tenth of the wavelength λ of the radiation beam. The tilt angles within this range are lower than a maximum possible tilt angle of the objective system with respect to the optical axis OA of approximately 0.5°. In a further embodiment of the present invention the tilt is alternatively varied by adjusting a tilt of the record carrier. This is achieved by varying the tilt of the mounting element holding the record carrier in accordance with the first and second tilt error signals. In this case the actuator is arranged to vary the tilt of the record carrier in this manner. It is further envisaged that the tilt misalignment is corrected by adjusting both the tilt of the objective system and the tilt of the record carrier simultaneously.

In the described embodiment of the present invention a initial tilt misalignment correction procedure is performed during a start-up procedure of the optical scanning device, for example prior to the actual scanning of the data from the optical record carrier. Once the tilt misalignment has been corrected, i.e. once the exit surface 22 and the outer surface 24 have the desired level of tilt alignment, the corrected tilt alignment is used and a further tilt control is enabled after the start-up procedure during the scanning function.

FIG. 4 shows a circular exit surface 22. A measuring region for the auxiliary radiation beam 21 is determined by the specific arrangement of the diffraction element 14. The diffraction element 14 comprises the transparent and unstructured center 15 so that the measuring region 60 comprises an inner boundary 61 defining a circular area 62 in the measuring region 60. The spot 44 of the main radiation beam 6 comprises a circular shape, wherein a profile or cross-sectional area of the spot 44 is arranged inside the inner boundary 61 and hence in the circular area 62 of the measuring region 60, wherein the beam profile of the main radiation beam 66, as shown by the spot 44 in FIG. 4, is separated from the measuring region 60 by a separating region 63 to avoid an influence of the auxiliary radiation beam 21 onto read-out or writing operations.

Further, an outer boundary 64 of the measuring region 60 is arranged inside the flat area of the tip of the objective lens 18, that is inside the exit surface 22 of the objective lens 18, including an edge spacing. In FIG. 4, the edge spacing is provided by a preferably small edge spacing ring 65. Preferably, the outer boundary 64 is as close to the edge of the exit surface 22 of the objective lens 18 as possible, but still inside the flat exit surface 22, wherein manufacturing tolerances are taken into account by the edge spacing ring 65.

Preferably, the same polarization state of the reflected radiation is used for tilt detection as for the gap error signal generation, as this part of the reflected radiation is insensitive to the data patterns on the record carrier 2. Therefore, the radiation detector 34 may be arranged to provide detection of the intensity distribution of the spot 46 as well as the intensity of a reflected radiation for the gap error signal generation, as shown in FIG. 5.

In FIG. 5, the radiation detector 34 comprises auxiliary radiation detector elements A, B, C, D and a main radiation detector element 66 for detecting an intensity of the main radiation beam reflected by the exit surface 22 of the objective lens 18 to produce the gap error signal. This has the advantage that only one radiation detector 34 is necessary for detection of both the reflected auxiliary radiation beams 21 and the radiation beam 6 reflected to produce the gap error signal. But, depending on the application, a further path may be provided comprising a further detector to generate the gap error signal.

Further, a detector element 34, as shown in FIG. 3, may be used one time for a detection of an intensity distribution of the reflected auxiliary radiation beam 21 and at another time for detection of the intensity of the main radiation beam 6 reflected to generate the gap error signal by combining the intensities measured by the different detector elements A, B, C, D.

In the described embodiment of the present invention, the record carrier 2 has an information layer and the outer surface 24 is a surface of this information layer. It is alternatively envisaged that the record carrier 2 has an information layer and a cover layer. One surface of the cover layer is the outer surface 24 whereas the information layer is arranged on the other surface of the cover layer. In this alternative embodiment the optical scanning device is adapted so that during the scanning function the main radiation beam is focused through the cover layer to a spot on the information layer. One such adaptation is a change in a thickness of the SIL along the optical axis.

The described embodiment of the present invention details the radiation detector arrangement as including a quadrant detector 34. Each detection quadrant area is a photodiode. It is alternatively envisaged that the detector arrangement includes a detector which is similar to a camera detector, for example a Charged Coupled Device (CCD).

The record carrier 2 as described in the detailed embodiment of the present invention is formed of silicon. It is further envisaged that the record carrier 2 is of a different construction and is formed of a plurality of layers including, for example for a read-only type disc, a polycarbonate layer and a metallic layer or a stack of dielectric layers. For a recordable type disc the plurality of layers is envisaged to include a polycarbonate layer and a layer formed of a material with a changeable phase or a magneto optical layer or a dye layer. The record carrier may comprise more than one information layer e.g. two, three, four or more.

The described embodiment of the present invention details the radiation beam 6 having a certain wavelength. It is envisaged that the radiation beam 6 has a different certain wavelength and the optical scanning device 3 and the record carrier 2 are suitably arranged to operate at this different certain wavelength. The record carrier 2 in the described embodiment of the invention is an optical record carrier, however it is envisaged in further embodiments that the optical scanning device 3 is adapted to scan different types of record carriers 2 including for example a disc employing hybrid recording such as heat assisted magnetic recording (HAMR) or a disc of a computer hard disc drive (HDD).

In the described embodiment of the present invention, a single radiation beam 6 is used for both the tilt misalignment correction procedure and the scanning function. It is alternatively envisaged that different radiation beams, generated by different radiation sources may be used for each of the tilt misalignment correction procedure and the scanning function. The different radiation sources may be used to generate radiation for scanning a different type of record carrier to that of the described embodiment.

In the described embodiment of the present invention, the first tilt axis 41 is perpendicular the optical axis OA and the second tilt axis 42 is perpendicular both the optical axis OA and the first tilt axis 41. In further embodiments of the present invention the first 41 and the second tilt axis 42 are envisaged to have a different spatial arrangement with respect to each other and to the optical axis OA.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device (3) for scanning a record carrier (2), said optical scanning device (3) comprises
an objective unit (20) adapted to transmit an auxiliary radiation beam (21) towards said record carrier (2) in a defocused mode in addition to at least a main radiation beam (6) to incident on said record carrier (2) for read-out and/or writing operations,
a diffraction element (14) adapted to diffract said auxiliary radiation beam (21) so as to at least define a measuring region (60) for said auxiliary radiation beam (21),
wherein said measuring region (60) is defined by said diffraction element (14) so as to enable a tilt control for said record carrier (2) with respect to an evanescent coupling of said auxiliary radiation beam (21) across a gap between an objective lens of said objective unit and said record carrier (2) while said main radiation beam (6) is used for read-out and/or writing operations.

2. An optical scanning device according to claim 1, characterized in that said diffraction element (14) generates said auxiliary radiation beam (21) from said main radiation beam (6).

3. An optical scanning device according to claim 2, characterized in that said diffraction element (14) comprises a transparent and unstructured center (15) for generating said main radiation beam (6) focused on a layer of said record carrier (2) by said objective unit (20) and a grating (16) for generating said auxiliary radiation beam (21).

4. An optical scanning device according to claim 3, characterized in that said grating (16) is a concentric grating.

5. An optical scanning device according to claim 1, characterized in that a beam profile (44) of said main radiation beam (6) is at least separated from said measuring region (60).

6. An optical scanning device according to claim 5, characterized in that said diffraction element (14) is adapted so that said measuring region (60) comprises a area (62), and that said objective unit (20) is adapted so that said beam profile (44) of said main radiation beam (6) is at least arranged inside said area (62).

7. An optical scanning device according to claim 6, characterized in that said diffraction element (14) is adapted so that said beam profile (44) of said main radiation beam (6) is separated form said measuring region (60) by a separating region (63).

8. An optical scanning device according to claim 7, characterized in that said objective lens comprises a tip (23), and that said diffraction element (14) is adapted so that a boundary (64) of said measuring region is arranged at least inside a flat area (22) of said tip (23) of said objective lens.

9. An optical scanning device according to claim 8, characterized in that said boundary (64) of said measuring region (60) is arranged inside said flat area (22) of said tip (23) of said objective lens (18) including an edge spacing (65).

10. An optical scanning device according to claim 9, characterized in that said measuring region (60) is at least nearly a ring shaped measuring region.

11. An optical scanning device according to claim 1, characterized by a radiation detector (34) that is arranged to produce a tilt error signal by detecting an intensity distribution of said auxiliary radiation beam (21) reflected by an exit surface (22) of said objective lens (18) of said objective unit (20).

12. An optical scanning device according to claim 11, characterized in that said radiation detector (34) is arranged for simultaneously generating said tilt error signal and a gap error signal by detecting an intensity of said main radiation beam (6) reflected by said exit surface of said objective lens (17).

13. An optical scanning device according to claim 12, characterized in that said radiation detector (34) comprises at least a main radiation detector element (66) for detecting an intensity of said main radiation beam (6) reflected by said exit surface (22) of said objective lens (18) to produce a gap error signal.

14. An optical scanning device according to claim 11, characterized in that said radiation detector (34) comprises a first auxiliary radiation detector element and at least a second auxiliary radiation detector element,
wherein said first auxiliary radiation detector element is arranged to detect an intensity of said auxiliary radiation beam (21) reflected by said exit surface (22) of said objective lens (18) with respect to a first part of said measuring region (60),
wherein said second auxiliary radiation detector element is arranged to detect an intensity of said auxiliary radiation beam (21) reflected by said exit surface (22) of said objective lens (18) with respect to a second part of said measuring region (60), and
wherein said radiation detector (34) is adapted to produce a tilt error signal on the basis of said intensity detected by said first auxiliary radiation detector element and said intensity detected by said second auxiliary radiation detector element.

15. An optical scanning device according to claim 14, characterized in that said radiation detector (34) comprises a third auxiliary radiation detector element and at least a fourth auxiliary radiation detector element,
wherein said third auxiliary radiation detector element is arranged to detect an intensity of said auxiliary radiation beam reflected by said exit surface (22) of said objective lens (18) with respect to a third part of said measuring region (60),
wherein said fourth auxiliary radiation detector element is arranged to detect an intensity of said auxiliary radiation beam reflected by said exit surface (22) of said objective lens (18) with respect to a fourth part of said measuring region, and wherein said radiation detector (34) is adapted to produce a tilt error signal representing a two-dimensional tilt misalignment between said exit face of said objective lens (18) and an outer surface (24) of said record carrier (2) on the basis of said intensity detected by said first auxiliary radiation detector element, said intensity detected by said second auxiliary radiation detector element, said intensity detected by said third auxiliary radiation detector element and said intensity detected by said fourth auxiliary radiation detector element.

16. An optical recording apparatus comprising an optical scanning device according to claim 1 arranged to simultaneously perform a gap distance correction and a tilt misalignment correction during scanning of a record carrier (2).

17. Method of scanning a record carrier (2), said method comprises the steps of:
transmit an auxiliary radiation beam (21) towards said record carrier (2) in a defocused mode in addition to at least a main radiation beam (6) onto said record carrier (2) for read-out and/or writing operations,
diffract said auxiliary radiation beam (21) so as to at least define a measuring region (60) for said auxiliary radiation beam (21),
wherein said measuring region (60) is defined so as to enable a tilt control for said record carrier (2) with respect to an evanescent coupling of said auxiliary radiation beam (21) across a gap between an objective lens (18) of an objective unit (20) used for scanning said record carrier (2), while said main radiation beam (6) is used for read-out and/or writing operations.
